(19) United States
(12) Patent Application Publication
(10) Pub. No.: US 2014/0338928 A1
(43) Pub. Date: Nov. 20, 2014

(54) METHOD FOR FIGHTING A FIRE OR A TEMPERATURE RISE IN A MATERIAL STORED IN A LARGE STORAGE FACILITY, A FIREFIGHTING SYSTEM AND USES HEREOF

(71) Applicants: Annette Marie Juggetta Mortensen, Borkop (DK); Natalia Valentinovna Bergholdt, Kolding (DK)

(72) Inventors: Annette Marie Juggetta Mortensen, Borkop (DK); Natalia Valentinovna Bergholdt, Kolding (DK)

(73) Assignee: RAMBOLL DANMARK A/S, Copenhagen S (DK)

(21) Appl. No.: 14/372,838

(22) PCT Filed: Jan. 24, 2012
(86) PCT No.: PCT/DK2012/000005

§ 371 Date: Jul. 17, 2014

(51) Int. Cl. A62C 3/04; A62C 35/11; A62C 37/36; A62C 3/06

(52) U.S. Cl. CPC A62C 3/04; A62C 3/06; A62C 35/11; A62C 37/36
USPC 169/45; 169/60

(57) ABSTRACT

A method and system for fighting a fire or a temperature rise in a material stored in a large storage facility such as a silo or a similar closed storage building for a biomass material, the method including detecting a fire or temperature rise in the stored material of the storage facility with detecting means, and applying liquid nitrogen to the interior of the storage facility from a firefighting system in the facility wherein the amount of applied liquid nitrogen is controlled with control means in relation to one or more values of the facility and/or stored material.

### TECHNICAL FIELD

The invention relates to a method for fighting a fire or a temperature rise in a material stored in a large storage facility, a firefighting system and uses hereof.

### BACKGROUND

Methods of fighting fires in stored material of large storage facilities, such as biomass silo storages, are well known in the art.

A fire in the stored material can self-ignite in or below the material surface and especially the latter type of fire may be difficult to extinguish.

Fire sprinkler systems supplying water or water containing foam have been used on fires in stored material but have a number of disadvantages including the fact that the stored material will soak water. The water soaked material may merge to a firm and heavy entity putting the structural integrity of the storage facility in danger.

Systems injecting an inert gas have also been used in fighting fires in stored material of large storage facilities. The inert gas may be based on nitrogen or carbon dioxide wherein the gas reduces the oxygen content in the atmosphere of the large storage facility and hereby smothers the fire without soaking the stored material. However, firefighting with injection of inert gas in large storage facility may be problematic as the reduction of oxygen content to a relevant level is time consuming and requires injection of large amounts of inert gas. Further, the systems require complicated nozzle units for establishing the inert gases for injection from a liquid and pressurized state e.g. by expansion and supply of heat.

Further systems inject liquid carbon dioxide which form a solid layer of dry ice on the stored material as well as reduces the oxygen content in the atmosphere of the large storage facility. However, applied dry ice creates a significant amount of static electricity which may initiate a dust or gas explosion in the atmosphere above the stored material.

Dust or gas explosions are generally a significant risk in connection with fires in stored material such as stored biomass material in large storage facilities which makes firefighting systems using liquid carbon dioxide less applicable.

The invention provides a method and a firefighting system for large storage facilities without the above mentioned disadvantage. Especially, the invention provides a method and system which quickly, efficiently and safely smothers a fire in stored material of a large storage facility.

### BRIEF SUMMARY

The invention relates to a method for fighting a fire or a temperature rise in a material stored in a large storage facility such as a silo or a similar closed storage building for a biomass material, said method comprising steps of:

detecting a fire or temperature rise in said stored material of the storage facility with detecting means, and

applying liquid nitrogen to the interior of the storage facility from one or more inlets of a firefighting system in said facility

wherein the amount of applied liquid nitrogen is controlled with control means in relation to one or more values of said facility and/or stored material.

The liquid nitrogen will enter the surface of the stored material and separate the area of fire or temperature rise from the atmosphere above stored material in the large storage facility. The separation provides a significant reduction in the danger of a dust or gas explosion in the large storage facility.

Liquid nitrogen boils at minus 195.79° C. and will gradually vaporize into a gas when injected into the warmer atmosphere of the large storage facility. The liquid nitrogen and the subsequently vaporized nitrogen gas will fill the large storage facility and hereby reduce the oxygen content in the atmosphere of the facility. Further, the injected liquid nitrogen may be injected at a high flow and will reduce the temperature of the large storage facility significantly.

The injected liquid nitrogen will altogether smother the fire or remove a temperature rise quickly and efficiently as well as safely reduce the danger of a dust or gas explosion when applied in a controlled manner.

The term “closed storage building” is to be understood as a building which is sufficiently closed to hold a nitrogen gas atmosphere for a time period i.e. a building without significant openings to the exterior which permit a swift air replacement.

The term “temperature rise” is to be understood as a rise in temperature indicating that a fire start is about to happen in the stored material.

In an aspect of the invention, said liquid nitrogen is applied in a controlled sequence. Hereby it is possible to control the environment of the storage facility with the amount of liquid nitrogen applied in relation to values of the facility and/or stored material e.g. reducing the amount for a time period in response to a low temperature value in the facility.

In another aspect of the invention, said liquid nitrogen is applied in a controlled sequence with a period of applying liquid nitrogen separated from the next period of applying liquid nitrogen by an idle period. The idle time periods between the time periods of applying liquid nitrogen ensure that the temperature in the large storage facility does not drop below a minimum temperature e.g. a minimum temperature defined by the facility walls, roof or foundation in order to avoid any structurally damage to the facility structure from the temperature of the injected liquid nitrogen.

In an aspect of the invention, liquid nitrogen is applied in a controlled sequence with a period of applying liquid nitrogen separated from the next period of applying liquid nitrogen by a period of applying less liquid nitrogen. The “less” time periods between the time periods of applying the “full” amount of liquid nitrogen may also ensure that the temperature in the large storage facility does not drop below a minimum temperature. The differences in applied liquid nitrogen may for example be used in connection with a larger and more temperature intense fire wherein a significant flow of nitrogen is necessary to handle the fire but still requires some control of the injected liquid nitrogen to avoid any structurally damage to the facility.

In an aspect of the invention, the duration of said idle or less liquid nitrogen period is defined by one or more detected values of said facility and/or stored material. Hereby is achieved a more accurate and efficient control of liquid nitrogen applied to the stored material in the large storage facility as the applied liquid nitrogen amount may be controlled in relation to—for example—presently detected values of temperatures and/or degree of inerting/oxygen level.

In an aspect of the invention, one or more temperature values are detected in and/or inside the storage facility such as in the facility walls, roof and foundation, on the surfaces of the walls, roof and/or foundation and/or in close proximity of the walls, roof and/or foundation surfaces. Hereby is ensured that a temperature of the storage facility is not reduced to a level wherein the structural parts may be damaged e.g. temperature levels which will reduce the carrying ability of concrete walls or steel roof in a storage facility.

In an aspect of the invention, a degree of inerting is detected inside the storage facility e.g. in the atmosphere above the stored material and/or in an upper layer of the stored material.

In an aspect of the invention, liquid nitrogen is applied in relation to one or more structural values of the storage facility such as a minimum temperature value of the storage facility walls, roof and/or foundation or other structural parts of the facility.

In an aspect of the invention, liquid nitrogen is injected in the storage facility via one or more inlets such as one or more nozzles in the upper part of the facility and above the stored material. Hereby is it possible to inject liquid nitrogen into the atmosphere/room above the stored material whereby some liquid nitrogen will vaporize in the atmosphere and some liquid nitrogen will enter the stored material.

In an aspect of the invention, the direction of the liquid nitrogen is controlled by said one or more inlets. Hereby it is possible to direct liquid nitrogen to only a part of the storage material which indicates a temperature rise or fire or to for example avoid pouring liquid nitrogen directly on the facility walls.

In an aspect of the invention, liquid nitrogen is injected in the storage facility via some or all of said one or more inlets. Hereby it is possible to direct and control liquid nitrogen to parts of the stored material e.g. pouring liquid nitrogen on a center part of the stored material and not or less on parts close to the walls of the storage facility. Further, it is possible to direct liquid nitrogen to only a part of the storage material which indicates a temperature rise or fire.

The invention also relates to a firefighting system for a large storage facility with a material stored such as a silo or a similar closed storage building for a biomass material, said system comprising

detecting means for detecting a fire or a temperature rise in said stored material,

at least one reservoir with liquid nitrogen,

one or more inlets in said facility for applying liquid nitrogen from said at least one reservoir to the interior of the storage facility, and

control means for controlling the amount of liquid nitrogen applied to said storage facility in relation to one or more values of said facility and/or stored material.

Hereby is achieved a firefighting system which will advantageously smother the fire or remove a temperature rise quickly, efficiently and safely when the liquid nitrogen is applied in a controlled manner.

Hereby is achieved an advantageous firefighting system wherein the injected liquid nitrogen will smother the fire or remove a temperature rise quickly and efficiently as well as safely reduce the danger of a dust or gas explosion when applied in a controlled manner.

In an aspect of the invention, said control means include one or more temperature detectors for detecting one or more temperature values in the stored material and/or in the atmosphere above the stored material.

In an aspect of the invention, said control means include one or more detectors detecting the degree of inerting in the storage facility e.g. one or more oxygen sensors located in the atmosphere above the stored material and/or in an upper layer of the stored material.

In an aspect of the invention, said inlets include one or more nozzles located in the upper part of the storage facility and above the stored material e.g. in a distance from the facility walls.

In an aspect of the invention, said one or more inlets include one or more nozzles with a spiral shape e.g. spiral nozzles. Hereby is ensured that the liquid nitrogen is injected in an advantageous manner as a divided liquid nitrogen flow in form of a jet or jets and liquid nitrogen drops by the spiral shape.

In an aspect of the invention, said one or more inlets comprise screening means for injection of liquid nitrogen in direction of the storage facility walls. Hereby is ensured that any liquid nitrogen is screened from being poured directly on the storage facility walls.

In aspects of the invention, said one or more inlets is/are located on a central axis or away from the axis in the upper part of the storage facility. Hereby are ensured possibility of controlling the liquid nitrogen flow and especially the location in the storage facility/stored material which is poured liquid nitrogen on.

In an aspect of the invention, said control means comprises one or more pre-established values of said facility e.g. structural values such as a minimum temperature value of the storage facility walls, roof and/or foundation or other structural parts of the facility.

The invention also relates to uses of a method and firefighting system for fighting a fire or temperature rise in a silo or a similar closed storage building for biomass material e.g. wood pellets, woodchips or solid wastes in fuelling a power and/or heating plant.

In an aspect of the invention, the uses of a method and firefighting system are performed in a silo or similar closed storage building designed for storing more than 5.000 m3 and preferably more than 25.000 m3 of biomass material. Fighting fires in storages buildings of this size involve significant difficulties which often result in fires burning for days when using the existing firefighting methods and systems but applying liquid nitrogen on the stored material may quickly, efficiently and safely smother a fire in the material.

In another aspect of the invention, the uses of a method and firefighting system include a silo or similar closed storage building which is part of a power and/or heating plant, a manufacturing plant for biomass material or an intermediate storage location between the manufacturing plant and the power and/or heating plant. Biomass such as wood pellets are manufactured in plants from wastes of sawmills or the like and are generally stored in silos or similar closed storage buildings on the manufacturing location before the biomass is being transported to silos or similar closed storage buildings at harbors, train stations or similar transport location. Here from is the final transportation to a silo or similar closed storage building of a power and/or heating plant performed.

All the silos or similar closed storage buildings may advantageously include the use of the method and firefighting system of the invention.

### BRIEF DESCRIPTION OF THE DRAWINGS

The invention will be described in the following with reference to the figures in which

FIG. 1 schematically illustrates a power and/or heating plant supplied from a large storage facility,

FIG. 2 illustrates a cross view of the large storage facility with stored material inside,

FIG. 3a illustrates an enlarged part of FIG. 2 with the large storage facility and an embodiment of a firefighting system according to the invention,

FIG. 3b illustrates a preferred embodiment of an inlet in the firefighting system according to the invention,

FIG. 4 illustrates a flow diagram of an embodiment of the invention,

FIGS. 5a-c illustrate an embodiment of the invention with sequential control of applied liquid nitrogen and the resulting graphs of temperature and degree of inerting in the large storage facility, and

FIGS. 5d-f illustrate alternative embodiments of the invention with sequential control of applied liquid nitrogen.

### DETAILED DESCRIPTION

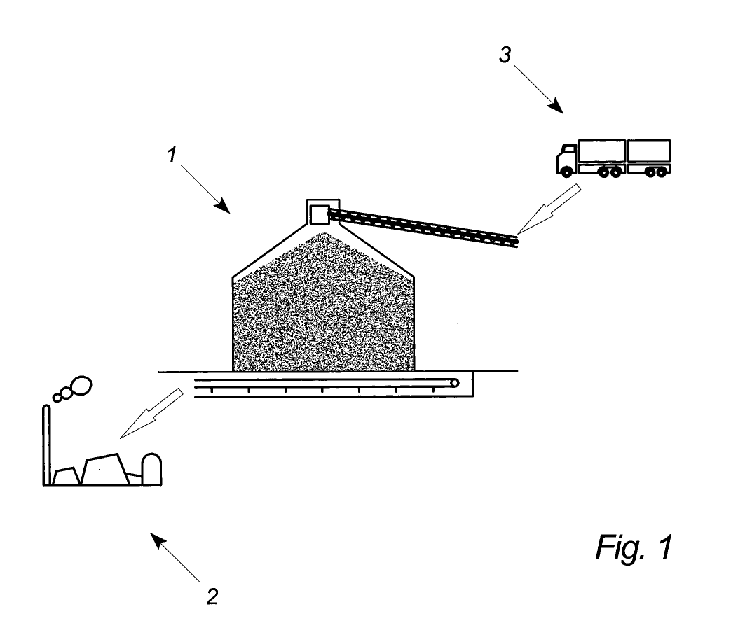

FIG. 1 schematically illustrates a power and/or heating plant 2 supplied from a large storage facility 1 with a solid biomass fuel such as wood pellets or wastes. The stored material in the large storage facility 1 is supplied with trucks, trains, ships or other vehicles 3 from a material supplier such as a manufacturer of wood pellets.

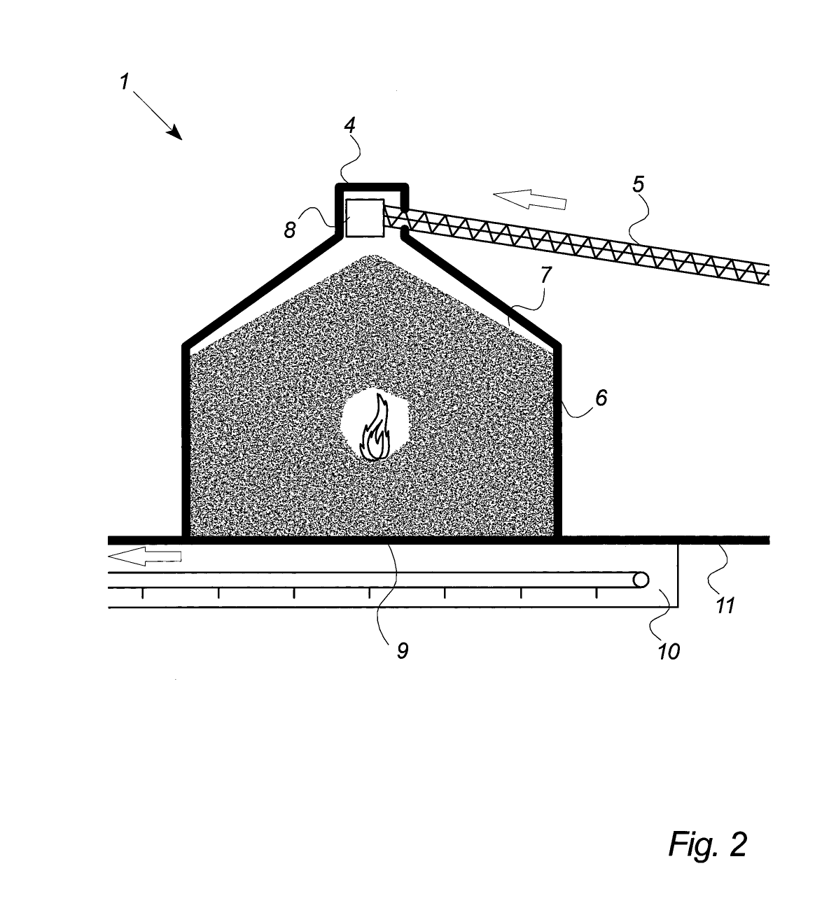

FIG. 2 illustrates a cross view of the large storage facility 1 from FIG. 1 with a pile of stored material 6 inside. The pile of stored material is also pictorially illustrated with a burning fire beneath the material surface.

The large storage facility 1 is defined by outer walls 4 holding the stored material 6 as well as a room 7 above the stored material. An upper part of one facility wall 4 has an opening for entry of a conveyor 5 acting as transport means for the material to be stored in the large storage facility 1. The conveyor ends in an inlet unit 8 inside the large storage facility 1 for delivering the material to be stored. The large storage facility 1 has also an outlet section 9 at ground level 11 with openings for delivering stored material to another conveyor 10 acting as transport means for transporting the material to the power and/or heating plant 2.

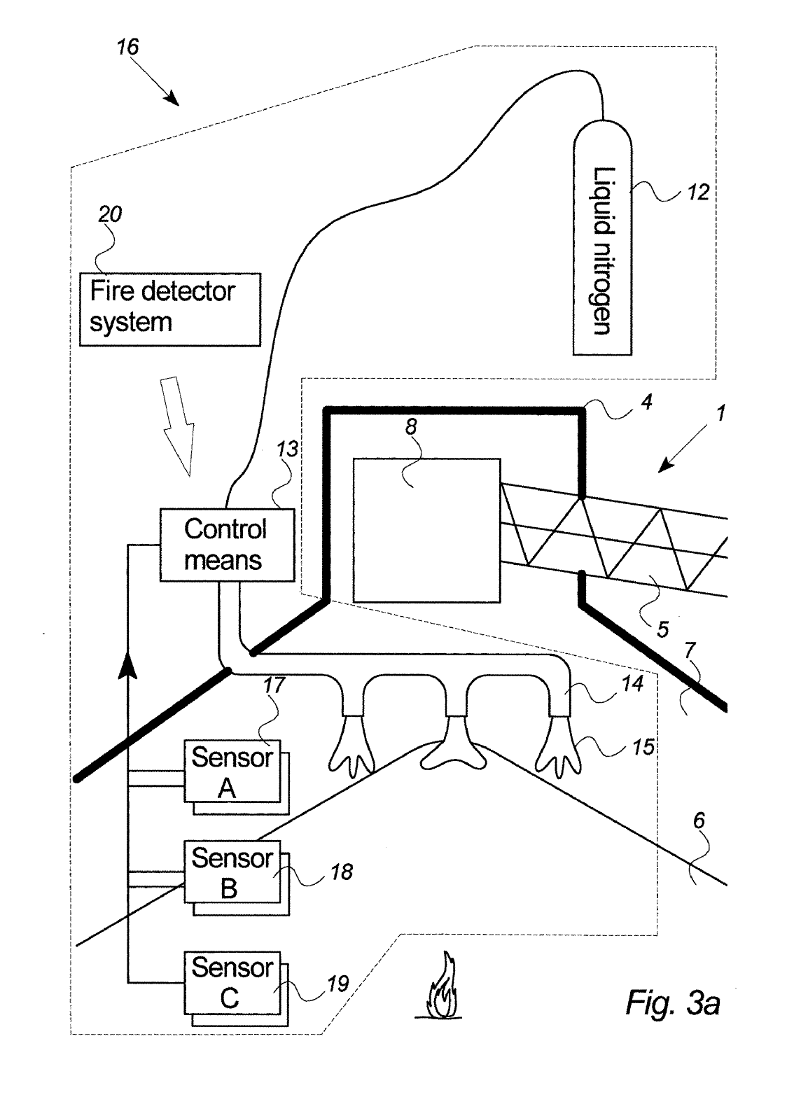

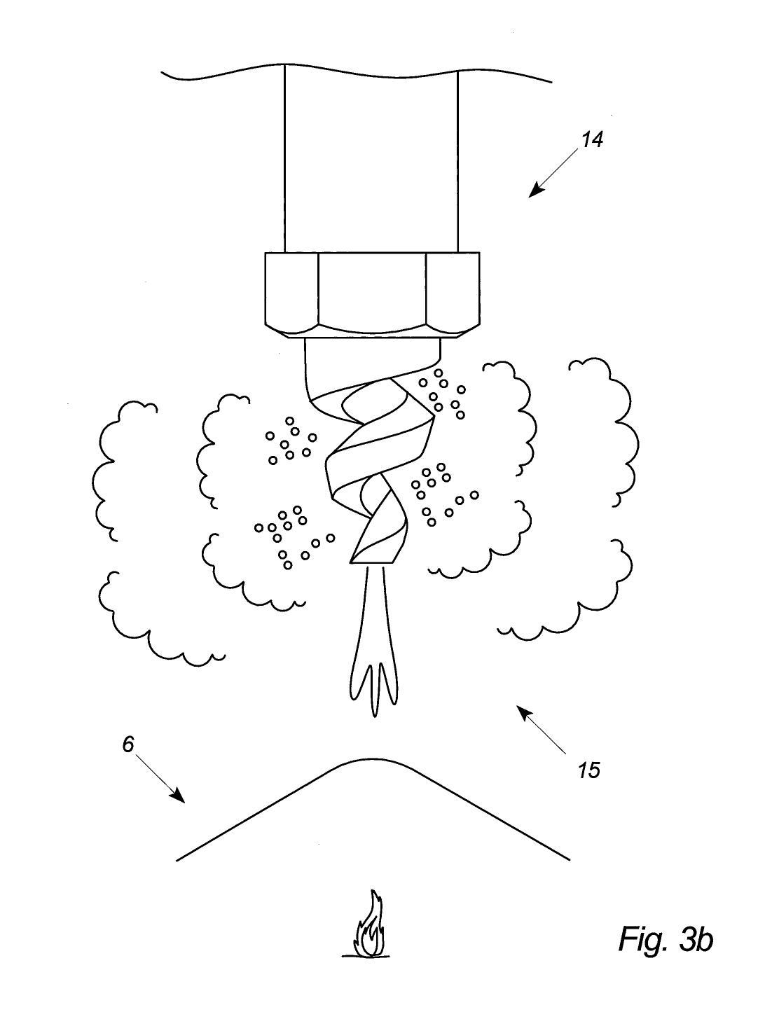

FIG. 3a illustrates an enlarged part of the large storage facility 1 from FIG. 2. The figure also illustrates an embodiment of a firefighting system 16 and an accompanying method according to the invention for fighting a fire (pictorially illustrated) in the stored material 6.

The firefighting system 16 comprises inlets 14 including one or more nozzles located in the upper part of the large storage facility wherein the inlets may apply liquid nitrogen 15 to the interior of the large storage facility.

The liquid nitrogen is supplied from a reservoir 12 for liquid nitrogen such as one or more stationary pressure tanks or tank trucks. The amount of liquid nitrogen 15 applied to the interior of the storage facility 1 is controlled with control means 13.

The control means 13 include a fire detector system 20 for initiating the firefighting system and a number of detector or sets of detectors for controlling the amount of applied liquid nitrogen e.g. one or more temperature detectors and/or degree of inerting detectors 17-19.

A fire detector system 20 in the firefighting system 16 may for example be separate detectors in the storage facility such as smoldering fire detectors detecting level values of CO, CO₂, H and/or NOₓ. Further, the fire detectors may survey temperatures in the storage facility and the stored material with separate temperature sensors e.g. temperature sensors lowered down into the stored material. Even further, the fire detector system may include infra cameras or the like as well as other means of detecting a fire including persons realizing that a fire is present or imminent in the stored material.

The detectors 17-19 for directly controlling the amount of applied liquid nitrogen may establish one or more values of the large storage facility and/or stored material 6 e.g. with degree of inerting/oxygen level sensors located in the atmosphere/room 7 above the stored material and/or lowered into the stored material. The detectors may also include temperature sensors located in proximity of structural parts in the storage facility such as sensors in or close to the walls, roof or foundation of the facility i.e. sensors detecting wall, roof or foundation temperatures.

Liquid nitrogen is—in an example—injected into a concrete silo of a diameter of 35 meter and a total volume of 20.000 m3 for smothering a fire or reducing a temperature rise. The silo stores 5.000 m3 of wood pellets and hereby comprises an atmosphere above the pellets of 15.000 m3 which is inertised by the injected liquid nitrogen to a final oxygen value of approx. 10% in the atmosphere. The oxygen value in the wood pellets will also fall to a similar value as the nitrogen enters biomass material but with a time delay in relation to the atmosphere.

The amount of injected liquid nitrogen in the example may be 200 to 300 liter per minute such as a flow of approx. 240 l/min. and approx. 10 to 13.000 kilogram liquid nitrogen if the injection in the silo is continued in approx. one hour in obtaining the above final oxygen value in the atmosphere and the biomass material of the silo.

FIG. 3b illustrates a preferred embodiment of an inlet in the firefighting system according to the invention. The inlet is illustrates with spiral shaped means at opening of the system opening.

The spiral ensures that a part of the liquid nitrogen is—as a central jet of liquid nitrogen—poured directly on the stored material and enters into the upper layer of the material.

Another part of the liquid nitrogen is spiraled out of the openings in the side of the spiral shaped means as drops of liquid nitrogen which may vaporize in the atmosphere/room above the stored material and inertise the atmosphere.

The inlets 14 may also be pipe openings in the embodiment which allow the liquid nitrogen to be injected substantially unobstructed into the interior of the storage facility and pour down on and into the stored material.

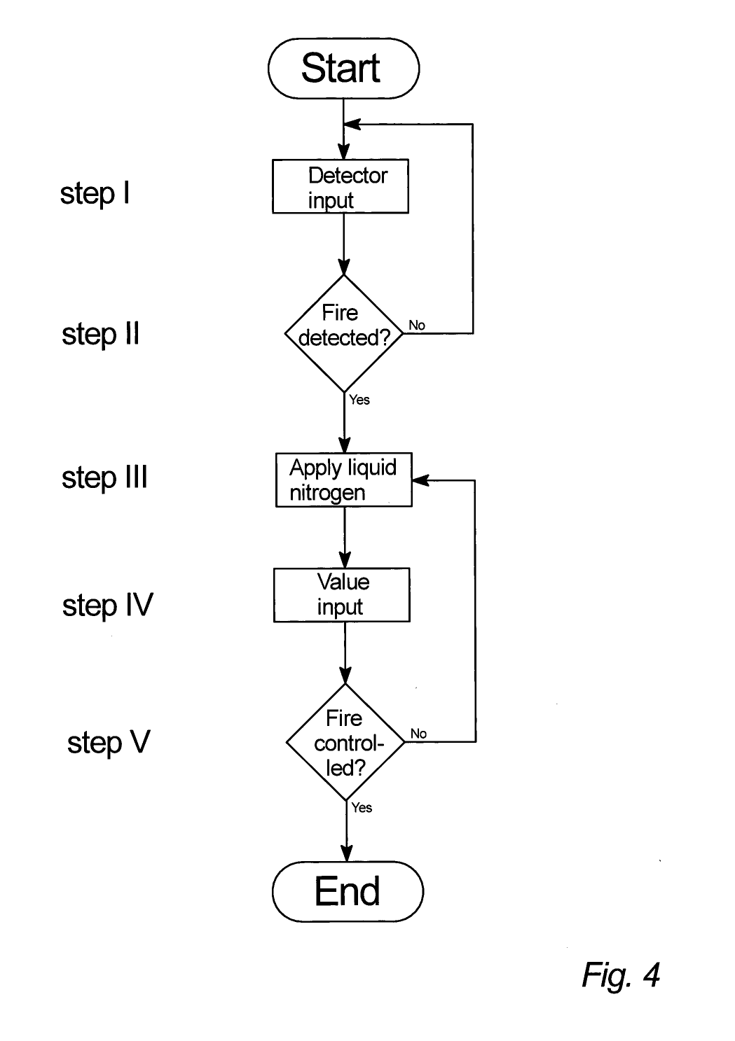

FIG. 4 illustrates a flow diagram of method steps in an embodiment of the invention.

The first method steps involve detection of a fire or temperature rise in the stored material of the large storage facility (steps I+II).

The first steps initiate application of liquid nitrogen to interior of a large storage facility with a firefighting system when a fire or temperature rise is detected (step III).

The amount of applied liquid nitrogen is controlled in relation to one or more value inputs of the large storage facility and/or stored material (step IV).

Liquid nitrogen is applied until the fire or temperature rise is detected to be under control or extinguished/removed (step V).

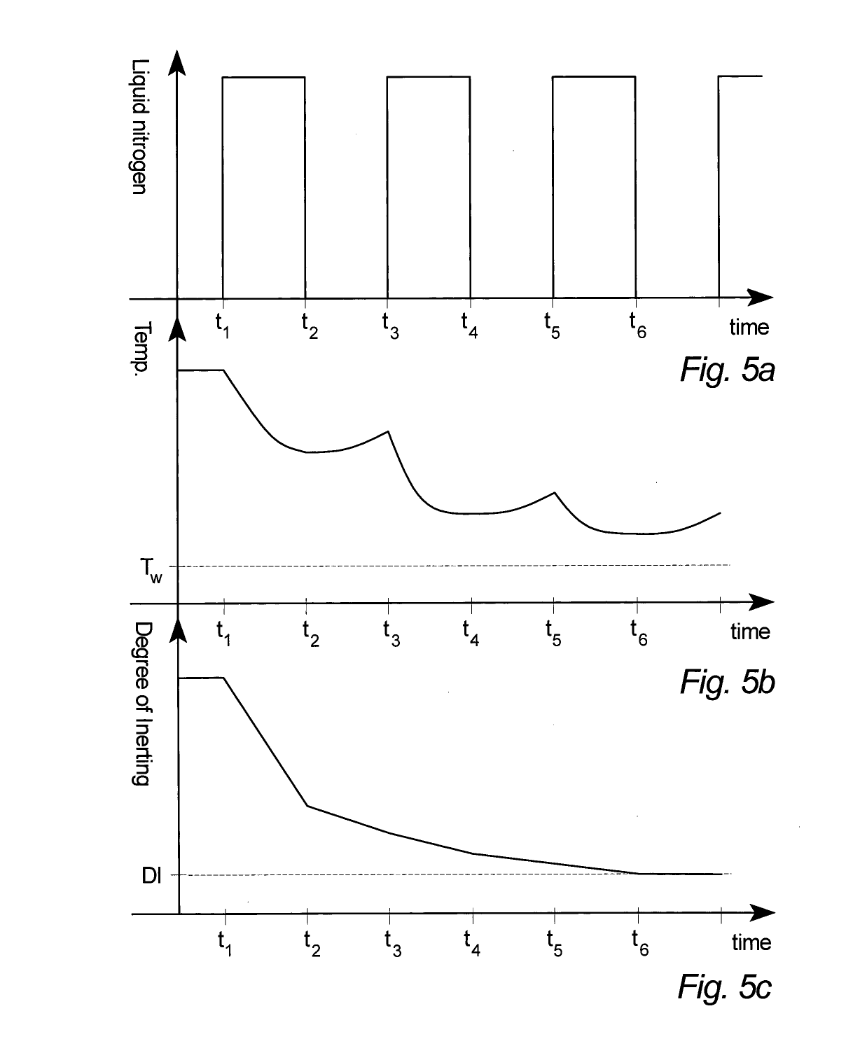

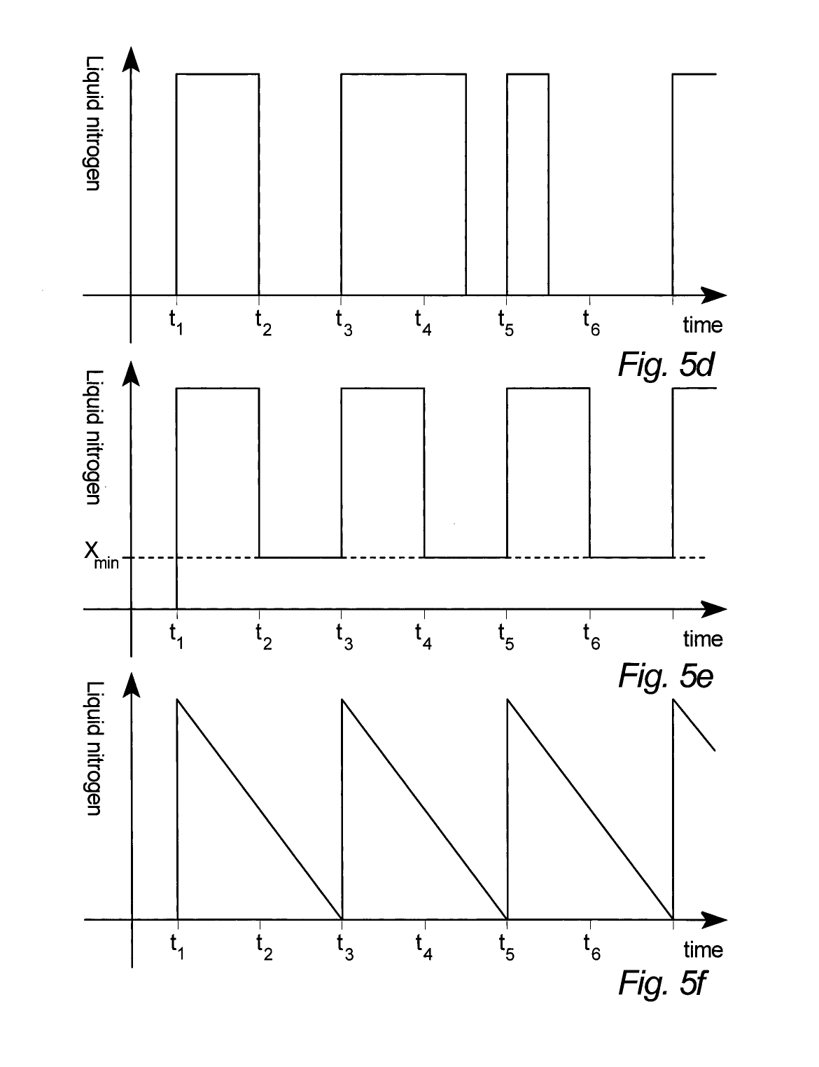

FIG. 5a illustrates an embodiment of the invention with sequential control of applied liquid nitrogen and the resulting graphs of temperature and degree of inerting detected in the large storage facility are illustrated in FIGS. 5b and 5c.

FIG. 5a illustrates the sequential control of the applied liquid nitrogen wherein liquid nitrogen is applied in a time period (t₁ to t₂) and stopped in a time period (t₂ to t₃). This control strategy is continued in the following time periods until the fire or temperature rise is detected to be under control or extinguished/removed (step V in FIG. 4) or the firefighting is changed for other reasons.

FIG. 5b illustrates the trend in a resulting temperature value detected in a location of the large storage facility during the sequential control of the applied liquid nitrogen e.g. the temperature at the storage walls or roof.

Initially the temperature is substantially constant until the first amount of liquid nitrogen is applied to the stored material in response to a detection of a fire or temperature rise. The applied liquid nitrogen will quickly lower the temperature in the time period (t₁ to t₂) but the temperature will increase in the next time period (t₂ to t₃) when no liquid nitrogen is applied. This temperature pattern will continue in the next time periods with the illustrated sequential control of the applied liquid nitrogen until the fire is extinguished or the temperature rise is removed. The sequential control of the applied liquid nitrogen ensures that the temperature in the large storage facility does not continue below a structural temperature T_{w} of—for example—the facility walls e.g. a minimum temperature wherein the walls may start sustaining structural damage.

FIG. 5c illustrates the trend in a resulting degree of inerting/oxygen level detected in a location of the large storage facility during the sequential control of the applied liquid nitrogen e.g. above or in the stored material. The applied liquid nitrogen will lower the oxygen level in the time period (t₁ to t₂) and the oxygen level will also be lowered in the next time periods of applying liquid nitrogen with the illustrated sequential control of the applied liquid nitrogen until the fire is extinguished or the temperature rise is removed.

However, the oxygen level will not change significantly in the time periods of no applied liquid nitrogen (e.g. t₂ to t₃) due to the relative airtightness of the large storage facility. The oxygen level DI illustrates a level wherein especially the danger of dust or gas explosions in the large storage facility is no longer present as well as a level wherein a fire is being smothered.

FIGS. 5d to 5f illustrate alternative embodiments of the invention with sequential control of applied liquid nitrogen.

The time periods of applying liquid nitrogen and idle time periods may be also be of different duration e.g. a long first time period of applying liquid nitrogen followed by shorter time periods of applying liquid nitrogen or short idle time periods between longer time period of applying liquid nitrogen or the like (FIG. 5d).

The amount of applied liquid nitrogen may also vary from one time period to the next e.g. full amount in one time period (t₁ to t₂) and less than full amount in the next time period (t₂ to t₃) wherein the less amount is controlled in relation to detected values of the storage facility and/or the stored material (FIG. 5e).

The amount of applied liquid nitrogen may also vary within a time period e.g. from initial full amount to less or no amount at the end of the period (FIG. 5f).

Combinations of two or more of the above sequential controls of applied liquid nitrogen are also possible (FIGS. 5a and 5d-5f).

It will also be understood that the invention is not limited to the particular examples described above but may be designed in a multitude of varieties within the scope of the invention, as specified in the claims. Especially, the sequential control of the liquid nitrogen may be altered in a number of ways e.g. in relation to time periods and amounts of liquid nitrogen applied to a given form of large storage facility and stored material. The detecting a fire or temperature rise in the stored material, temperature and degree of inerting/oxygen level may also be performed in numerous different ways besides the above described detector and sensor examples.

Firefighting

1. Method for fighting a fire or a temperature rise in a material stored in a large storage facility such as a silo or a similar closed storage building for a biomass material, said method comprising steps of:
detecting a fire or temperature rise in said stored material of the storage facility with detecting means, and
applying liquid nitrogen to an interior of the storage facility from one or more inlets of a firefighting system in said facility
wherein an amount of applied liquid nitrogen is controlled with control means in relation to one or more values of said facility and/or stored material.

2. Method according to claim 1, wherein said liquid nitrogen is applied in a controlled sequence.

3. Method according to claim 1, wherein said liquid nitrogen is applied in a controlled sequence with a period of applying liquid nitrogen separated from a next period of applying liquid nitrogen by an idle period.

4. Method according to claim 1, wherein liquid nitrogen is applied in a controlled sequence with a period of applying liquid nitrogen separated from a next period of applying liquid nitrogen by a period of applying less liquid nitrogen.

5. Method according to claim 3, wherein a duration of said idle or less liquid nitrogen period is defined by one or more detected values of said facility and/or stored material.

6. Method according to claim 1, wherein liquid nitrogen is applied in a controlled sequence with different amounts of liquid nitrogen applied during a time period comprising a higher initial amount and a lower final of liquid nitrogen.

7. Method according to claim 1, wherein one or more temperature values are detected in and/or inside storage walls, roof and foundation, on surfaces of the walls, roof and/or foundation and/or in close proximity of the walls, roof and/or foundation surfaces.

8. Method according to claim 1, wherein one or more temperature values are detected in the stored material and/or in atmosphere above the stored material.

9. Method according to claim 1, wherein a degree of inerting is detected inside the storage facility in the atmosphere above the stored material and/or in an upper layer of the stored material.

10. Method according to claim 1, wherein liquid nitrogen is applied in relation to one or more structural values of the storage facility comprising a minimum temperature value of storage facility walls, roof and/or foundation or other structural parts of the facility.

11. Method according to claim 1, wherein liquid nitrogen is injected in the storage facility via one or more inlets in the upper part of the facility and above the stored material.

12. Method according to claim 11, wherein the direction of the liquid nitrogen is controlled by said one or more inlets.

13. Method according to claim 12, wherein liquid nitrogen is injected in the storage facility via some or all of said one or more inlets.

14. Firefighting system for a large storage facility with a material stored such as a silo or a similar closed storage building for a biomass material, said system comprising
detecting means for detecting a fire or a temperature rise in said stored material,
at least one reservoir with liquid nitrogen,
one or more inlets in said facility for applying liquid nitrogen from said at least one reservoir to the interior of the storage facility, and
control means for controlling an amount of liquid nitrogen applied to said storage facility in relation to one or more values of said facility and/or stored material.

15. Firefighting system according to claim 14, wherein said control means include one or more temperature detectors for detecting one or more temperature values in the storage facility, the detectors comprising one or more temperature sensors located in facility walls, roof and/or foundation, on surfaces of the walls, roof and/or foundation, and/or in close proximity of the wall, roof and/or surfaces.

16. Firefighting system according to claim 14, wherein said control means include one or more temperature detectors for detecting one or more temperature values in the stored material and/or in atmosphere above the stored material.

17. Firefighting system according to any of claim 14, wherein said control means include one or more detectors detecting the degree of inerting in the storage facility, the detectors comprising one or more oxygen sensors located in the atmosphere above the stored material and/or in an upper layer of the stored material.

18. Firefighting system according to claim 14, wherein said one or more inlets include one or more nozzles located in an upper part of the storage facility and above the stored material in a distance from the facility walls.

19. Firefighting system according to claim 18, wherein said one or more inlets include one or more nozzles with a spiral shape.

20. Firefighting system according to claim 18, wherein said one or more inlets comprise screening means for injection of liquid nitrogen in a direction of the storage facility walls.

21. Firefighting system according to claim 20, wherein said one or more inlets is/are located on a central axis in the upper part of the storage facility.

22. Firefighting system according to claim 18, wherein said one or more inlets are located away from a central axis in the upper part of the storage facility.

23. Firefighting system according to claim 14, wherein said control means comprises one or more pre-established values of said facility comprising minimum temperature value of storage facility walls, roof and/or foundation or other structural parts of the facility.

24. A method for fighting a fire or temperature rise according to claim 1, wherein the method is performed in a silo or a similar closed storage building for biomass material comprising wood pellets, woodchips or solid wastes in fuelling a power and/or heating plant.

25. Firefighting system according to claim 14, configured in a silo or a similar closed storage building for biomass material comprising wood pellets, woodchips or solid wastes in fuelling a power and/or heating plant.

26. Method according to claim 24, further comprising design the silo or similar closed storage building for storing more than 5.000 m3 of biomass material.

27. Firefighting system according to claim 25, wherein the silo or similar closed storage building is part of a power and/or heating plant, a manufacturing plant for biomass material or an intermediate storage location between the manufacturing plant and the power and/or heating plant.
